(19) United States
(12) Patent Application Publication
(10) Pub. No.: US 2012/0180000 A1
(43) Pub. Date: Jul. 12, 2012

(54) METHOD AND SYSTEM FOR SIMULATING THREE-DIMENSIONAL OPERATING INTERFACE

(75) Inventors: Ming-Che Weng, Taipei City (TW); Wei-Ling Hsu, Taipei City (TW); Yu-Jen Huang, Taipei City (TW); Pei-Fen Deng, Taipei City (TW); Chun-Cheng Chen, Taipei City (TW); Shi-Kuan Chen, Taipei City (TW); Hong-Tien Wang, Taipei City (TW)

(73) Assignee: COMPAL ELECTRONICS, INC., Taipei City (TW)

(21) Appl. No.: 13/073,974

(22) Filed: Mar. 28, 2011

(30) Foreign Application Priority Data
Jan. 10, 2011 (TW) 100100833

(51) Int. Cl. G06F 3/048

(52) U.S. Cl. 715/848

(57) ABSTRACT

A method and a system for simulating a three-dimensional (3D) operating interface are provided. The method includes defining a partition line to partition a display frame of a screen into a first area and a second area, and defining a size of a unit grid to establish a first grid plane and a second grid plane in the first area and the second area respectively, the first grid plane and the second grid plane forming a simulated 3D grid space. The method also includes taking the unit grid as a unit to define an object size and an initial grid coordinate of an object. The initial grid coordinate is on one of the first and the second grid planes. The method further includes mapping out a simulated 3D space in the simulated 3D grid space for displaying the object according to the initial grid coordinate and the object size.

### CROSS-REFERENCE TO RELATED APPLICATION

This application claims the priority benefit of Taiwan application serial no. 100100833, filed Jan. 10, 2011. The entirety of the above-mentioned patent application is hereby incorporated by reference herein and made a part of this specification.

### BACKGROUND OF THE INVENTION

1. Field of the Invention

The present invention relates to an operating interface of an electronic device, and particularly to a method and system for simulating a three-dimensional operating interface.

2. Description of Related Art

The advancement in technology has impelled manufacturers of electronic devices to not only focus on improvement of hardware efficacy but also devote more effort on software design when developing products. It is not difficult to envision that whether the user interface is easy to operate directly influences the user's impression on the electronic device. As such, there are more and more design improvements on user interfaces on the market aiming to provide the user with better operation experience.

Take smart phones as an example. Smart phones of earlier generations are configured with desktops similar to the designs of desktops of computer systems, which, however, have evolved to various widgets that can be dragged to the screen according to user preferences. The user may arrange the dispositions of the widgets and thus create a personalized user interface. In detail, the widget is a generic type of software which has the characteristics of miniature and easy disposition and provides certain simple functions.

The popularity and prevalence of the widget enhances the convenience in the interaction between the user and the electronic device and allows the user to create a user interface specifically for himself/herself. However, in the current electronic products, most manufacturers design two-dimensional operating interfaces so as not to increase system workload, and the graphic designs of the widgets are often limited to two-dimensional graphics.

In practice, if three dimensional display is needed, a simulation method is often used. For example, US patent application (US20080307360) disclosing a user operating interface using three-dimensional display mainly teaches disposing icons on a simulated side wall or side surface.

### SUMMARY OF THE INVENTION

In light of this, the present invention provides a method for simulating a three-dimensional operating interface to simulate the effects of a three-dimensional space on an operating interface of an electronic device.

The present application provides a system for simulating a three-dimensional operating interface to simulate a three-dimensional operating space having three-dimensional objects on an electronic device.

The present application provides a method for simulating a three-dimensional operating interface used on an electronic device having a screen. The method includes defining a partition line on a display frame of the screen to divide the display frame into a first area and a second area. A size of a unit grid is defined. A first grid plane and a second grid plane are established respectively in the first area and the second area, the first grid plane and the second grid plane forming a simulated three-dimensional grid space. The method further includes defining an object size of an object and an initial grid coordinate using the unit grid as a basic unit. The object size is determined based on a projection of the object onto the first grid plane or the second grid plane. The initial grid coordinate is on the first grid plane or the second grid plane. In the simulated three-dimensional grid space, a simulated three-dimensional space is mapped out to display the object according to the initial grid coordinate and the object size.

In one embodiment of the present invention, the step of mapping out a simulated three-dimensional space according to the initial grid coordinate and the object size to display the object includes using a partition line to determine if the initial grid coordinate is on the first grid plane or the second grid plane. When the initial grid coordinate is on the first grid plane, the simulated three-dimensional space is made to be located on the first grid plane. When the initial grid coordinate is on the second grid plane, the simulated three-dimensional space is made to be located on the second grid plane.

In one embodiment of the present invention, after the step of mapping out the simulated three-dimensional space to display the object, the method for simulating a three-dimensional operating interface further includes receiving a moving instruction for the object. The object is made to move in the simulated three-dimensional grid space in alignment with grids on the first grid plane or the second grid plane according to the moving instruction.

In one embodiment of the present invention, the step of making the object move in the simulated three-dimensional grid space in alignment with the grids on the first grid plane or the second grid plane according to the moving instruction includes determining a current grid coordinate according to the initial grid coordinate and a displacement corresponding to the moving instruction. The unit of the displacement is based on the unit grid. The partition line is used to determine whether the current grid coordinate is on the first grid plane or the second grid plane. A current three-dimensional space is mapped out to display the object according to the current grid coordinate and the object size. When the current grid coordinate is on the first grid plane, the current three-dimensional space is made to be located on the first grid plane, and when the current gird coordinate is on the second grid plane, the current three-dimensional space is made to be located on the second grid plane.

In one embodiment of the present invention, the step of mapping out the current three-dimensional space according to the current grid coordinate and the object size to display the object further includes changing an appearance of the object when displaying the object if the current grid coordinate and the initial grid coordinate are located on different grid planes on the first grid plane and the second grid plane.

In one embodiment of the present invention, the step of mapping out the current three-dimensional space according to the current grid coordinate and the object size to display the object further includes mapping out a spare three-dimensional space according to the current three-dimensional space and displaying the object in the spare three-dimensional space if other objects exist in the simulated three-dimensional grid space and are displayed in the current three-dimensional space.

In one embodiment of the present invention, the object is an icon of a widget or a shortcut to an application program.

From another perspective, the present invention provides a system for simulating a three-dimensional operating interface including a space mapping module and an object drawing module. The space mapping module is for defining a partition line on a display frame of a screen to divide the display frame into a first area and a second area and for defining a size of a unit grid to establish a first grid plane and a second grid plane respectively in the first area and the second area. The first grid plane and the second grid plane form a simulated three-dimensional grid space. The object drawing module is coupled to the space mapping module and defines an object size of an object and an initial grid coordinate using the unit grid as a basic unit. The initial grid coordinate is on the first grid plane or the second grid plane. The object drawing module is further for mapping out a simulated three-dimensional space to display the object according to the initial grid coordinate and the object size.

In one embodiment of the present invention, the object drawing module uses the partition line to determine whether the initial grid coordinate is on the first grid plane or the second grid plane. When the initial grid coordinate is on the first grid plane, the object drawing module makes the simulated three-dimensional space located on the first grid plane, and when the initial gird coordinate is on the second grid plane, the object drawing module makes the simulated three-dimensional space located on the second grid plane.

In one embodiment of the present invention, when the object drawing module receives a moving instruction for the object, the object drawing module makes the object move in the simulated three-dimensional grid space in alignment with grids on the first grid plane or the second grid plane according to the moving instruction.

In one embodiment of the present invention, the object drawing module determines a current grid coordinate based on the initial grid coordinate and a displacement corresponding to the moving instruction. A unit of the displacement is based on the unit grid. The object drawing module uses the partition line to determine if the current grid coordinate is on the first grid plane or the second grid plane and maps out a current three-dimensional space to display the object according to the current grid coordinate and the object size. When the current grid coordinate is on the first grid plane, the object drawing module makes the current three-dimensional space located on the first grid plane, and when the current gird coordinate is on the second grid plane, the object drawing module makes the current three-dimensional space located on the second grid plane.

In one embodiment of the present invention, the object drawing module changes an appearance of the object being displayed when the current grid coordinate and the initial grid coordinate are located on different grid planes on the first grid plane and the second grid plane.

In one embodiment of the present invention, if other objects exist in the simulated three-dimensional grid space and are displayed in the current three-dimensional space, the object drawing module maps out a spare three-dimensional space according to the current three-dimensional space and displays the object in the spare three-dimensional space.

In one embodiment of the present invention, the object is an icon of a widget or a shortcut to an application program.

According to the above, the present invention uses two grid planes to define a simulated three-dimensional grid space and allows an object representing a widget or an application program to have thickness in the three-dimensional grid space. As such, when the user moves the object in the simulated three-dimensional grid space, the object is made to move in alignment with the grids and does not overlap with other objects. Thereby, the user feels the effects of operating in a three-dimensional environment.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a system for simulating a three-dimensional operating interface according to one embodiment of the present invention.

FIG. 2 is a flow chart of a method for simulating a three-dimensional operating interface according to one embodiment of the present invention.

FIG. 3 is a schematic view illustrating establishment of a first grid plane and a second grid plane on a display frame of a screen according to one embodiment of the present invention.

FIG. 4 and FIG. 5 are schematic views illustrating display of an object on a first grid plane and a second grid plane according to one embodiment of the present invention.

FIG. 6 is a flow chart illustrating movement of an object according to one embodiment of the invention.

FIG. 7 and FIG. 8 are schematic views illustrating display of an object on a first grid plane and a second grid plane according to another embodiment of the present invention.

### DESCRIPTION OF EMBODIMENTS

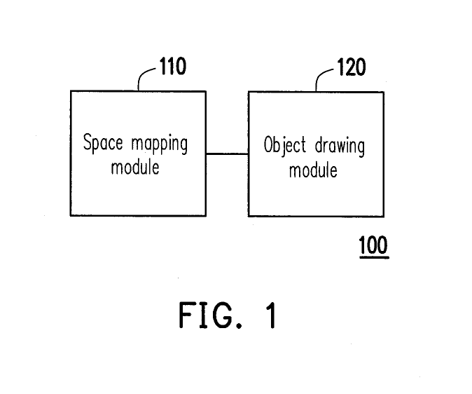

FIG. 1 is a block diagram of a system for simulating a three-dimensional operating interface according to one embodiment of the present invention. Referring to FIG. 1, a system for simulating a three-dimensional operating interface 100 includes a space mapping module 110 and an object drawing module 120. The space mapping module 110 and the object drawing module 120 are coupled to each other. In the present embodiment, the system for simulating a three-dimensional operating interface 100 can be disposed in any mobile electronic device having a screen such as a cellular phone, a person digital assistant (PDA), a smart phone, a tablet personal computer (Tablet PC), an electronic book, etc.

The space mapping module 110 is for establishing a simulated three-dimensional grid space on a display frame of a screen. The object drawing module 120 is for displaying icons of various widgets or shortcuts to application programs as three-dimensional objects in the simulated three-dimensional grid space and allows the user to perform move operations on the objects in the simulated three-dimensional grid space, wherein the widgets and the application programs are executable by an electronic device. In the present embodiment, the space mapping module 110 and the object drawing module 120 are implemented using program codes, hardware devices, or a combination of program codes and hardware devices.

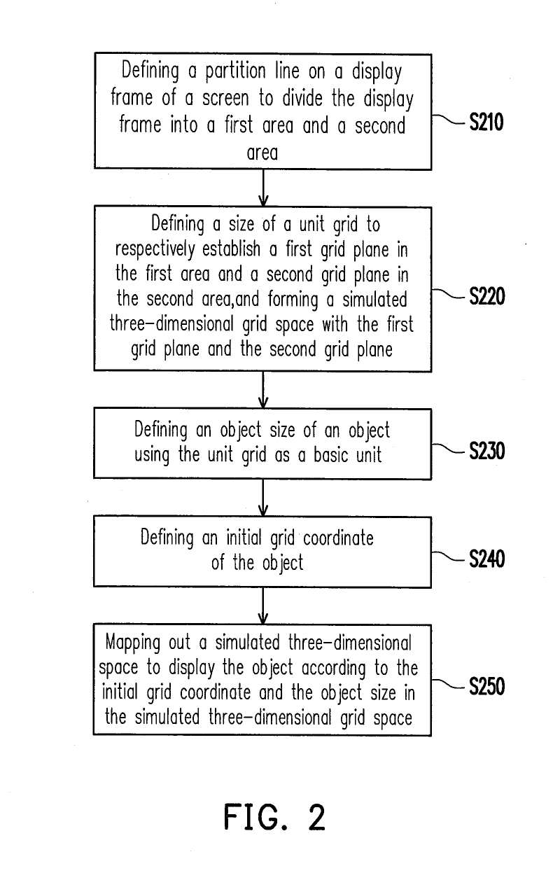

To further illustrate the detailed operations of the system for simulating a three-dimensional operating interface 100, another embodiment of the present invention is described below. FIG. 2 is a flow chart of a method for simulating a three-dimensional operating interface according to one embodiment of the present invention. Refer to both FIG. 1 and FIG. 2 at the same time.

First in step S210, the space mapping module 110 defines a partition line on a display frame of a screen to divide the display frame into a first area and a second area. Then, as shown in step S220, the space mapping module 110 defines a size of a unit grid and establishes a first grid plane and a second grid plane respectively in the first area and the second area. Besides, the space mapping module 110 forms a simulated three-dimensional grid space with the first grid plane and the second grid plane.

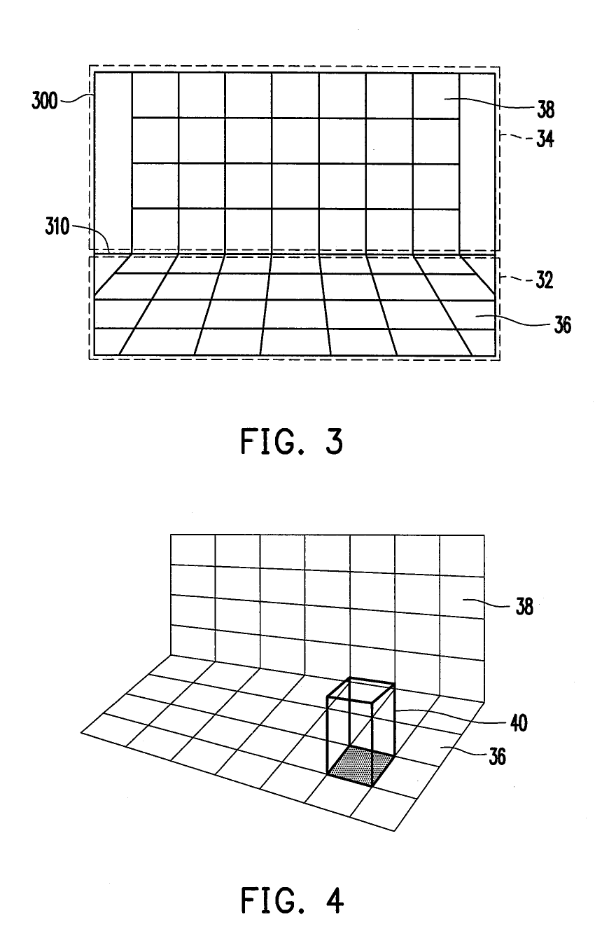

FIG. 3 is a schematic view illustrating establishment of a first grid plane and a second grid plane on a display frame of a screen according to one embodiment of the present invention. Referring to FIG. 3, on a display frame 300, the space mapping module 110 uses a partition line 310 that is defined to divide the display frame 300 into a first area 32 and a second area 34. In the present embodiment, the partition line 310 is a horizontal line on the display frame 300. However, the present invention is not limited thereto. In other embodiments, the partition line may be any diagonal line on the display frame.

In addition, the space mapping module 110 divides 6×4 grids respectively in the first area 32 and the second area 34 according to the size of the unit grid, further establishes a first grid plane 36 of size 6×4 in the first area 32, and establishes a second grid plane 38 of size 6×4 in the second area 34, the first grid plane 36 and the second grid plane 38 forming a simulated three-dimensional grid space. The first grid plane 36 is regarded as a ground of the simulated three-dimensional grid space and the second grid plane 38 is regarded as a wall of the simulated three-dimensional grid space. In the present embodiment, the first grid plane 36 and the second grid plane 38 have the same number of grids. However, in other embodiments, the space mapping module 110 may divide different numbers of grids in the first area 32 and the second area 34 and establish two grid planes of varying sizes.

Then, as shown in step S230, the object drawing module 120 defines an object size of an object using the unit grid as a basic unit. The object is, for example, an icon of a widget or a shortcut to an application program, which is provided for the user to directly select to execute the widget or activate the application program. The object size is determined by a projection of the object onto the first grid plane or the second grid plane. The definition of the object size allows the object to be an object with thickness in the simulated three-dimensional grid space.

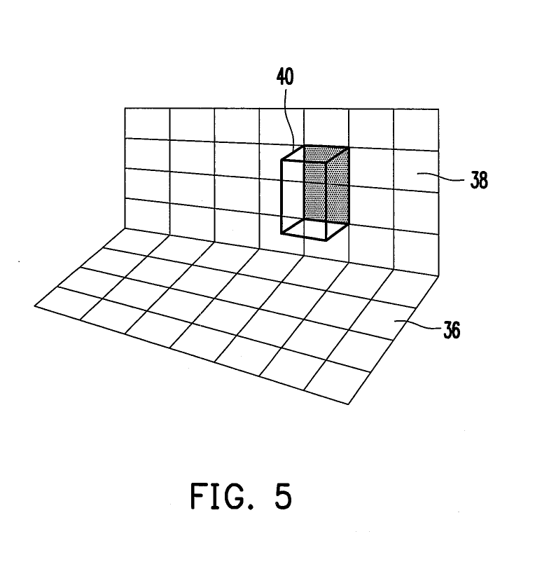

Take an object 40 in FIG. 4 as an example. The number of grids of the object 40 projected onto the first grid plane 36 is 1×1. Therefore, in the present embodiment, the projection of the object 40 onto the first grid plane 36 is 1×1 (also referred to as a first space parameter). As shown in FIG. 5, the number of grids of the object 40 projected onto the second grid plane 38 is 1×2. Therefore, in the present embodiment, the projection of the object 40 onto the second grid plane 38 is 1×2 (also referred to as a second space parameter).

Then, as shown in step S240, the object drawing module 120 defines an initial grid coordinate of the object. In the present embodiment, the initial grid coordinate is on the first grid plane or the second grid plane, and is represented in the form of (m, n). It should be especially stated that in the present embodiment, a three-dimensional grid space is simulated on a two-dimensional display frame. Therefore, the initial grid coordinate of each object only includes two parameters. The partition line defined by the space mapping module 110 is required to determine if the initial grid coordinate is on the first or second grid plane.

Finally in step S250, the object drawing module 120 maps out a simulated three-dimensional space in the simulated three-dimensional grid space to display the object according to the initial grid coordinate and the object size. Specifically, the object drawing module 120 determines a size of the simulated three-dimensional space according to the object size, and then uses the partition line to determine if the initial grid coordinate is on the first grid plane or the second grid plane. If the initial grid coordinate is on the first grid plane, the object drawing module 120 makes the simulated three-dimensional space located on the first grid plane. If the initial grid coordinate is on the second grid plane, the object drawing module 120 makes the simulated three-dimensional space located on the second grid plane. Then, the object is displayed in the simulated three-dimensional space. In other words, if the first grid plane is regarded as the ground of the simulated three-dimensional grid space, and the second grid plane is regarded as the wall of the simulated three-dimensional grid space, the object drawing module 120, when displaying the object, places the object on the first grid plane or pastes the object onto the second grid plane, without the object floating in the simulated three-dimensional grid space.

As described above, the space mapping module 110 uses the first grid plane to create the effect of depth of field and uses the second grid plane to provide different display height of the object, thereby simulating a three-dimensional grid space. As the object has two space parameters (projections) respectively projected onto the first grid plane and the second grid plane, the object drawing module 120 is able to create a three-dimensional effect in the simulated three-dimensional grid space using a two-dimensional object.

If the screen of the electronic device is a touch screen, after the space mapping module 110 maps out a simulated three-dimensional grid space on the display frame of the screen and the object drawing module 120 displays the object in the simulated three-dimensional grid space, the user is able to move the object in the simulated three-dimensional grid space through touch operations applied on the touch screen.

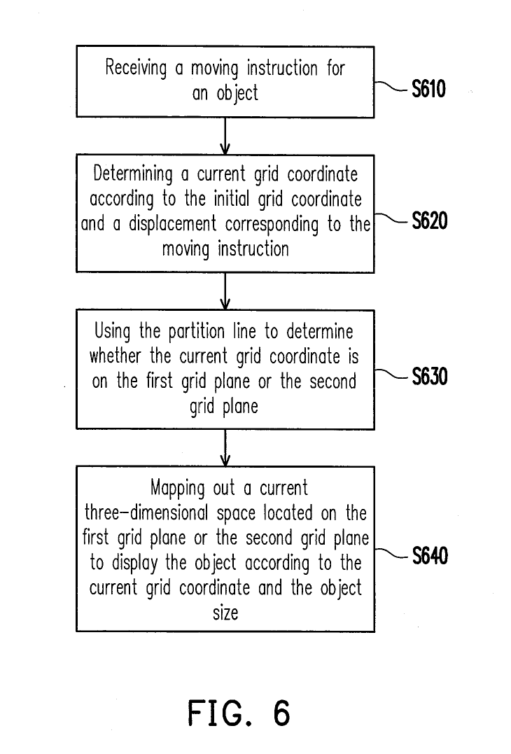

FIG. 6 is a flow chart illustrating movement of an object according to one embodiment of the invention. Refer to FIG. 6. First as shown in step S610, when the user selects an object on the touch screen and moves the finger or input tool, the object drawing module 120 receives a moving instruction for the object.

Then as shown in step S620, the object drawing module 120 determines a current grid coordinate based on the initial grid coordinate and a displacement corresponding to the moving instruction. In the present embodiment, a unit of the displacement is based on the unit grid. For example, the object drawing module 120 determines a distance of the user moving the finger or input tool according to the moving instruction and converts the distance into a number of girds moving to a certain direction. As such, the initial grid coordinate can be correspondingly adjusted to obtain the current grid coordinate.

Then in step S630, the object drawing module 120 uses the partition line to determine whether the current grid coordinate is on the first grid plane or the second grid plane. Finally in step S640, the object drawing module 120 maps out a simulated three-dimensional space located on the first grid plane or the second grid plane to display the object according to the current grid coordinate and the object size. In detail, the object drawing module 120 determines a size of the current three-dimensional space based on a projection of the object onto the first grid space and a projection of the object onto the second grid space. It is then determined on which grid plane the current three-dimensional space should be placed according to a location of the current grid coordinate. When the current grid coordinate is on the first grid plane, the object drawing module 120 makes the current three-dimensional space located on the first grid plane and then displays the object in the current three-dimensional space. When the current grid coordinate is on the second grid plane, the object drawing module 120 makes the current three-dimensional space located on the second grid plane and then displays the object in the current three-dimensional space.

As the object drawing module 120 uses the unit grid to calculate the displacement, when the user wishes to move the object, the object drawing module 120 ensures that the object moves in the simulated three-dimensional grid space in alignment with the grids on the first grid plane or the second grid plane according to the moving instruction, partition line, and object size.

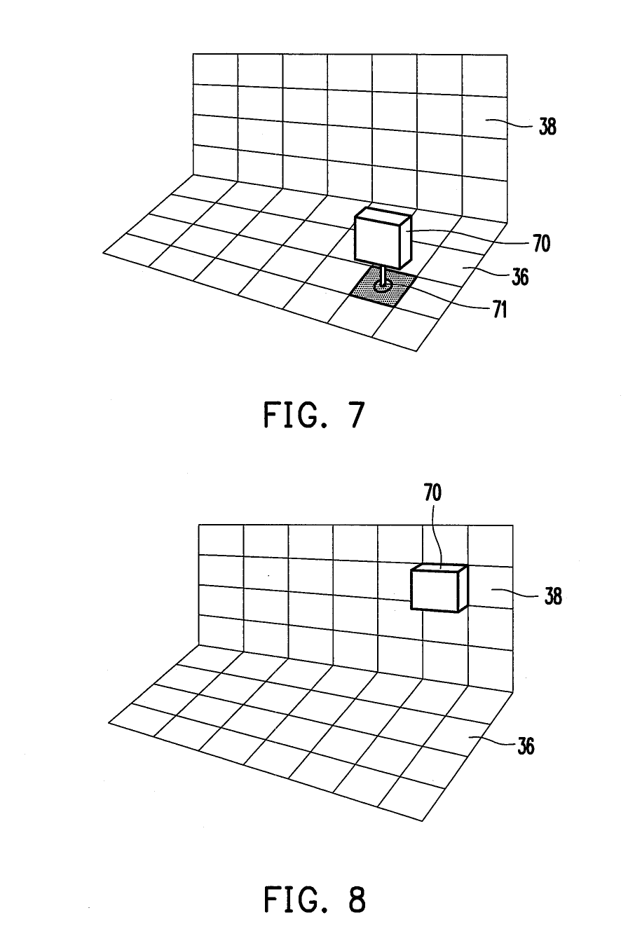

In another embodiment, if the current grid coordinate and the initial grid coordinate are on different grid planes on the first grid plane and the second grid plane, this means that the user moves the object from one grid plane to the other grid plane. In response, the object drawing module 120 changes an appearance of the object when displaying the object. Refer to both FIG. 7 and FIG. 8 at the same time. Assume the initial grid coordinate of an object 70 is on the first grid plane 36. As shown in FIG. 7, when the object 70 is placed on the first grid plane 36, the appearance of the object 70 has a support 71. When the user moves the object 70 on the first grid plane 36, the object drawing module 120 shows the support 71 of the object 70. However, when the user moves the object 70 to the second grid plane 38, as shown in FIG. 8, the object drawing module 120 changes the appearance of the object 70 and does not show the support of the object 70.

In addition, if other objects exist in the simulated three-dimensional grid space and are displayed in the current three-dimensional space, the object drawing module 120 maps out a spare three-dimensional space according to the current three-dimensional space. For example, the spare three-dimensional space having the same size as the current three-dimensional space is defined at a place around the current three-dimensional space where there are no objects being placed, and the object is displayed in the spare three-dimensional space. As such, it is ensured that all the objects displayed in the simulated three-dimensional grid space do not overlap and the simulation of displaying objects in a real three-dimensional space is more realistic.

In summary, the method and system for simulating a three-dimensional operating interface of the present invention use two grid planes on a display frame of a screen to simulate a three-dimensional grid space so as to ensure that objects move in the simulated three-dimensional grid space in alignment with the grids and thus do not overlap. If the desktop or other operation frame of an electronic device is presented by a simulated three-dimensional grid space, the user is provided with a more novel and interesting operating experience. Furthermore, using two-dimensional planes and objects to simulate the effect of a three-dimensional space also provide an advantage of lower computation complexity, thereby reducing system workload.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for simulating a three-dimensional operating interface for an electronic device having a screen, the method comprising:
defining a partition line on a display frame of the screen to divide the display frame into a first area and a second area;
defining a size of a unit grid;
establishing a first grid plane in the first area and establishing a second grid plane in the second area, the first grid plane and the second grid plane forming a simulated three-dimensional grid space;
defining an object size of an object and an initial grid coordinate using the unit grid as a basic unit, wherein the initial grid coordinate is located on the first grid plane or the second grid plane; and
mapping out a simulated three-dimensional space to display the object according to the initial grid coordinate and the object size in the simulated three-dimensional grid space.

2. The method for simulating a three-dimensional operating interface according to claim 1, wherein the step of mapping out the simulated three-dimensional space to display the object according to the initial grid coordinate and the object size comprises:
using the partition line to determine whether the initial grid coordinate is on the first grid plane or the second grid plane;
making the simulated three-dimensional space located on the first grid plane when the initial grid coordinate is on the first grid plane; and
making the simulated three-dimensional space located on the second grid plane when the initial grid coordinate is on the second grid plane.

3. The method for simulating a three-dimensional operating interface according to claim 1, wherein after the step of mapping out the simulated three-dimensional space to display the object, the method further comprises:
receiving a moving instruction for the object; and
making the object move in the simulated three-dimensional grid space in alignment with grids on the first grid plane or the second grid plane according to the moving instruction.

4. The method for simulating a three-dimensional operating interface according to claim 3, wherein the step of making the object move in the simulated three-dimensional grid space in alignment with grids on the first grid plane or the second grid plane according to the moving instruction comprises:
determining a current gird coordinate according to the initial grid coordinate and a displacement corresponding to the moving instruction, wherein a unit of the displacement is based on the unit grid;
using the partition line to determine whether a current grid coordinate is on the first grid plane or the second grid plane; and
mapping out a current three-dimensional space to display the object according to the current grid coordinate and the object size, wherein when the current grid coordinate is on the first grid plane, the current three-dimensional space is made to be located on the first grid plane, and when the current gird coordinate is on the second grid plane, the current three-dimensional space is made to be located on the second grid plane.

5. The method for simulating a three-dimensional operating interface according to claim 4, wherein the step of mapping out the current three-dimensional space to display the object according to the current grid coordinate and the object size further comprises:
changing an appearance of the object when displaying the object if the current grid coordinate and the initial grid coordinate are on different grid planes on the first grid plane and the second grid plane.

6. The method for simulating a three-dimensional operating interface according to claim 4, wherein the step of mapping out the current three-dimensional space to display the object according to the current grid coordinate and the object size further comprises:
mapping out a spare three-dimensional space according to the current three-dimensional space if other objects exist in the simulated three-dimensional grid space and are displayed in the current three-dimensional space; and
displaying the object in the spare three-dimensional space.

7. The method for simulating a three-dimensional operating interface according to claim 1, wherein the object is an icon of a widget or a shortcut to an application program.

8. The method for simulating a three-dimensional operating interface according to claim 1, wherein the object size is determined by a projection of the object onto the first grid plane or the second grid plane.

9. A system for simulating a three-dimensional operating interface, comprising:
a space mapping module, defining a partition line on a display frame of a screen to divide the display frame into a first area and a second area and defining a size of a unit grid to respectively establish a first grid plane in the first area and a second grid plane in the second area using the unit grid as a basic unit, the first grid plane and the second grid plane forming a simulated three-dimensional grid space; and
an object drawing module, coupled to the space mapping module, defining an object size of an object and an initial grid coordinate using the unit grid as the basic unit, the initial grid coordinate being located on the first grid plane or the second grid plane, and mapping out a simulated three-dimensional space to display the object in the simulated three-dimensional grid space according to the initial grid coordinate and the object size.

10. The system for simulating a three-dimensional operating interface according to claim 9, wherein the object drawing module uses the partition line to determine if the initial grid coordinate is on the first grid plane or the second grid plane,
when the initial grid coordinate is on the first grid plane, the object drawing module makes the simulated three-dimensional space located on the first grid plane, and when the initial gird coordinate is on the second grid plane, the object drawing module makes the simulated three-dimensional space located on the second grid plane.

11. The system for simulating a three-dimensional operating interface according to claim 9, wherein when the object drawing module receives a moving instruction for the object, the object drawing module makes the object move in the simulated three-dimensional grid space in alignment with grids on the first grid plane or the second grid plane according to the moving instruction.

12. The system for simulating a three-dimensional operating interface according to claim 11, wherein the object drawing module determines a current grid coordinate according to the initial grid coordinate and a displacement corresponding to the moving instruction, a unit of the displacement being based on the unit grid, determines if the current grid coordinate is on the first grid plane or the second grid plane using the partition line, and maps out a current three-dimensional space to display the object according to the current grid coordinate and the object size,
when the current grid coordinate is on the first grid plane, the object drawing module makes the current three-dimensional space located on the first grid plane, and when the current gird coordinate is on the second grid plane, the object drawing module makes the current three-dimensional space located on the second grid plane.

13. The system for simulating a three-dimensional operating interface according to claim 12, wherein the object drawing module changes an appearance of the object when the current grid coordinate and the initial grid coordinate are on different grid planes on the first grid plane and the second grid plane.

14. The system for simulating a three-dimensional operating interface according to claim 12, wherein if other objects exist in the simulated three-dimensional grid space and are displayed in the current three-dimensional space, the object drawing module maps out a spare three-dimensional space according to the current three-dimensional space and displays the object in the spare three-dimensional space.

15. The system for simulating a three-dimensional operating interface according to claim 9, wherein the object is an icon of a widget or a shortcut to an application program.
